(19) United States
(12) Patent Application Publication
(10) Pub. No.: US 2025/0284338 A1
(43) Pub. Date: Sep. 11, 2025

(54) Haptic Features for Touchscreens

(71) Applicant: The Boeing Company, Arlington, VA (US)

(72) Inventor: William Robert Bosworth, Somerville, MA (US)

(21) Appl. No.: 18/597,022

(22) Filed: Mar. 6, 2024

(51) Int. Cl. G06F 3/01; G06F 3/041; G06F 3/16

(52) U.S. Cl. CPC G06F 3/016; G06F 3/041; G06F 3/167

(57) ABSTRACT

A touch screen haptic system having a plurality of actuators for providing input is provided. The system comprises a number of actuators attached to a touch screen, wherein each actuator comprises: an outer ring and an inner membrane with an open area that exposes an actuator of the touch screen to touch.

### BACKGROUND INFORMATION

### Technical Field

The present disclosure relates generally to touch screens, and more specifically to haptic devices to provide user tactile feedback during use of touch screens.

### Background

Touch screens are input devices that allow users to interact with a computer or electronic device by making contact with the screen, usually with one or more of their fingers. These screens can detect and respond to touch input, allowing users to control the device, navigate menus, and input data without the need for traditional input devices like a mouse or keyboard.

In recent years, touch screens have been incorporated into automative vehicles, integrating touch-sensitive displays within dashboards and console displays. Automotive vehicle touch screen systems can be used to serves useful purposes such as to operate vehicle settings and controls, an entertainment system, climate controls, and communications, as well as to access diagnostic information. Doing so, however, requires a driver to view the touch screen, which is disadvantageous and even dangerous while driving. In fact, for this reason, some automotive touch screens can only be used while the vehicle is in park.

### SUMMARY

An illustrative embodiment provides a touch screen haptic system having a plurality of actuators for providing input. The system comprises a number of actuators attached to a touch screen, wherein each actuator comprises: an outer ring and an inner membrane with an open area that exposes an actuator of the touch screen to touch.

Another illustrative embodiment provides a touch screen haptic system having a number of actuators for providing input. The system comprises an overlay material placed over a touch screen. A number of open areas are defined within the overlay material to provide tactile access to the actuators. Edges of the open areas are in sized and/or shaped to provide tactile feedback to a user regarding the approximate locations of the actuators.

Another illustrative embodiment provides a touch screen haptic system having a plurality of actuators for providing input. The system comprises an overlay material placed over a touch screen. A number of open areas are defined within the material to provide tactile access to the actuators. Portions of the open regions are sized and/or shaped to provide tactile feedback to a user regarding the approximate locations of the actuators. A number of membrane actuators area also attached to the touch screen, wherein the membrane actuators are located within the open regions of the grid. Each membrane actuator comprises an outer ring and a flexible inner membrane with an open center that exposes a touch activated actuator to touch.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a touch screen haptic device system in accordance with an illustrative embodiment;

FIG. 2 depicts a block diagram of a touch screen with which the illustrative embodiments can be implemented;

FIG. 3A depicts a perspective view of a grid mounted to a touch screen in accordance with an illustrative embodiment;

FIG. 3B depicts a side cross-section view of the grid mounted on the touch screen;

FIG. 4A depicts a diagram of mechanical membrane actuators to provide haptic feedback for a touch screen actuator press in accordance with an illustrative embodiment;

FIG. 4B depicts a side cross-section view of the membrane actuators mounted on the touch screen; and

FIG. 5 is a diagram of a hybrid haptic system including a mechanical grid and membrane actuators in accordance with an illustrative embodiment.

### DETAILED DESCRIPTION

The illustrative embodiments recognize and take into account that touch screens have become more common in automotive vehicles, integrating touch-sensitive displays within dashboards and console displays.

The illustrative embodiments also recognize and take into account that a benefit of such touchscreens is that it is very simple to create “nested” screen of information. It is also fairly easy to create a “new” screen for interfacing with each new feature.

The illustrative embodiments also recognize and take into account that touch screens have eliminated vast amounts of physical buttons from consoles, but they are significantly more difficult to operate while operating a vehicle, e.g., when a driver should be focusing their visual attention onto the road. Because of lack of tactile feedback or other audible indicators, it is nearly impossible to operate a touch screen without looking directly at it.

The illustrative embodiments provide haptic feedback to touch screen operators to improve the ability of users to “navigate or find” the desired buttons they wish to press, as well as ensure that an intended press achieves desired result, while at the same time minimizing-if not entirely eliminating the necessity for-visual attention in furtherance of navigating the touchscreen display. The haptic feedback also helps ensure the user “knows” that the press has been accepted.

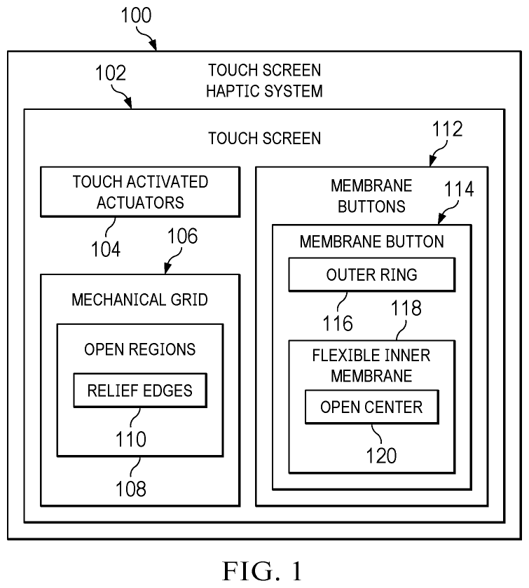

With reference now to FIG. 1, a block diagram of a touch screen haptic system is depicted in accordance with an illustrative embodiment. Touch screen haptic system 100 comprises a touch screen 102 comprising a number of touch activated actuators 104 (e.g., “buttons”).

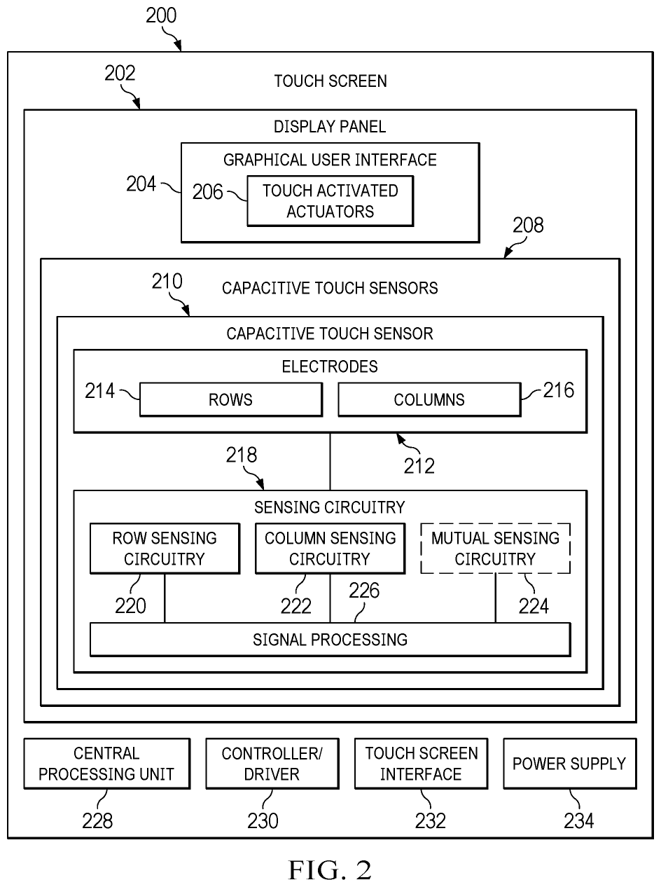

A mechanical grid or other framework of material 106 is placed over the touch screen 102 (see FIGS. 2A and 2B). The mechanical grid 106 can be permanently or detachably attached to or otherwise placed in physical communication with/to the touch screen 102. The mechanical grid 106 comprises a number of open regions 108 within which at least a subset of the touch activated actuators 104 are exposed to touch. Relief edges 110 of the open regions 108 are in raised relief to the touch screen 102 to provide tactile feedback to a user regarding the approximate locations of the touch activated actuators 104.

In furtherance of facilitating non-visual differentiation between each open region 108, some or all of the relief edges 110 can be raised to varying extents. Additionally, or alternatively, and to serve the same non-visual differentiation purpose, some or all open regions 108 can be non-identically sized and/or shaped, or otherwise patterned.

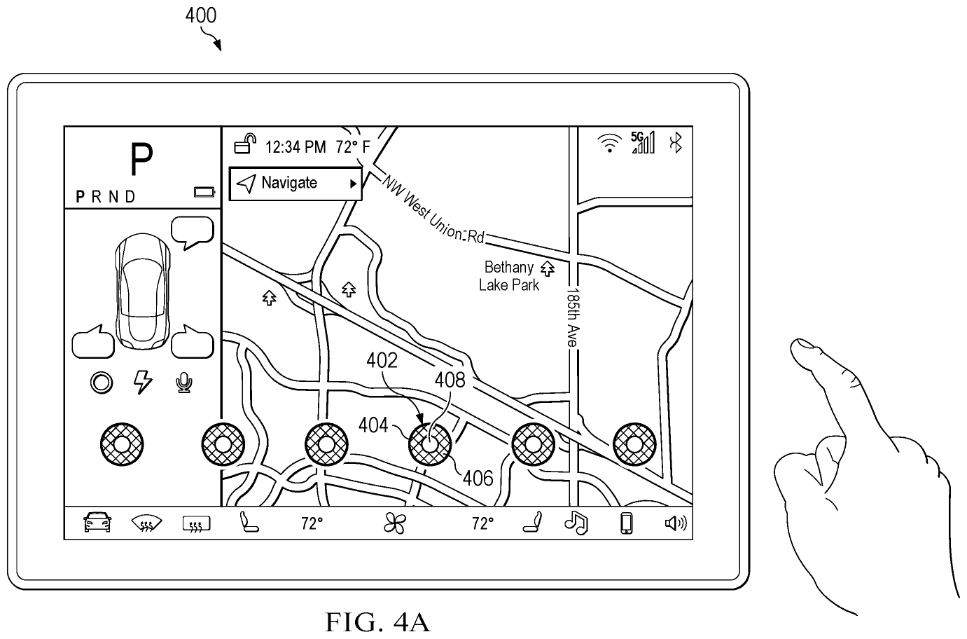

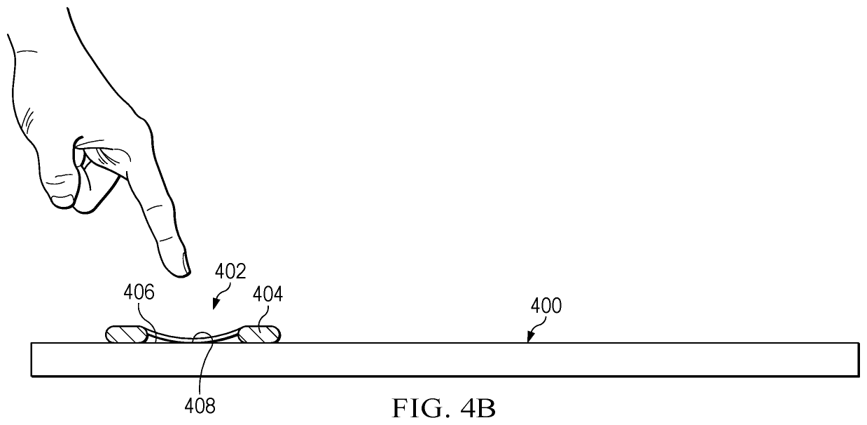

Touch screen haptic system 100 might also comprise a number of membrane actuators 112 attached to or otherwise in physical communication with/to the touch screen 102 (see FIGS. 4A and 4B). Membrane actuators 112 can be used in conjunction with mechanical grid 106 or by themselves without the mechanical grid. If the membrane actuators 112 are used in conjunction with the mechanical grid 106 the membrane actuators can be located within the open regions 108 of the grid (see FIG. 4). Each membrane actuator 114 comprises an outer shaped area (e.g. an outer ring) 116 and a flexible inner membrane 118. The outer ring 116 might be rigid or semi-rigid. The flexible inner membrane 118 has open center 120 that exposes one of the touch activated actuators 104 to touch.

Like the mechanical grid 106, the membrane actuators 112 can be permanently or detachably attached to the touch screen 102 or otherwise in physical communication with/to the touch screen.

FIG. 2 depicts a block diagram of a touch screen with which the illustrative embodiments can be implemented. Touch screen 200 is an example implementation of touch screen 102 shown in FIG. 1.

Touch screen 200 is integrated with a display panel 202 such as an LCD (liquid crystal display) or OLED (organic light emitting diode) display to provide visual feedback to users and enable interaction with a graphical user interface (GUI) 204. Display panel 202 comprises a number of capacitive touch sensors 208 which comprise the underlying hardware for implementing touch activated actuators 206 (e.g., “buttons”) in GUI 204.

Capacitive touch sensors 208 use the electrical properties of the human body to detect touch. Each touch sensor 210 might comprise a transparent conductive material such as indium tin oxide (ITO) on a glass or plastic surface. Other types of touch sensors such as infrared, surface acoustic wave, or optical imaging can also be used.

Each capacitive touch sensor 210 comprises a number of electrodes 212 arranged in rows 214 and columns 216 embedded in or located beneath the surface of the touch panel 202. When a finger or conductive object touches the display panel 202, it disturbs the electrostatic field between the electrodes 212, causing a change in capacitance of the electrodes.

Each of the electrodes 212 is connected to sensing circuitry 218 responsible for measuring changes in electrode capacitance. Row sensing circuitry 220 is responsible for driving signals to electrodes 212 in a given row and detecting changes in capacitance. Row sensing circuitry 220 typically includes oscillators or charge/discharge circuits. Column sensing circuitry 222 is responsible for measuring capacitance changes in a given column of electrodes 212 and converting these changes into electrical signals. Alternatively, sensing circuitry 218 might comprise mutual sensing circuitry 224 that drives signals to both rows 214 and columns 216 simultaneously and measures the capacitance changes between each row and column intersection.

The electrical signals generated by the row sensing circuitry 220, column sensing circuitry 222, and mutual sensing circuitry 224, are fed into signal processing 226. Signal processing, 226 may include amplification, filtering, and analog-to-digital conversion (ADC) to digitize the signals for further analysis.

Controller/driver 230 processes touch input signals and communicates with the device's operating system and/or software. By analyzing the changes in capacitance across multiple electrodes 212, as provided by signal processing 226, the controller/driver 230 can calculate the precise position of the touch on display panel 202.

Touch screen interface 232 facilitates communication between the device's hardware or software and the capacitive touch sensors 208 and controller/driver 230.

Central processing unit (CPU) 228 processes touch input and renders visual content in graphical user interface 204.

Power supply 234 provides power to the other components of touch screen 200.

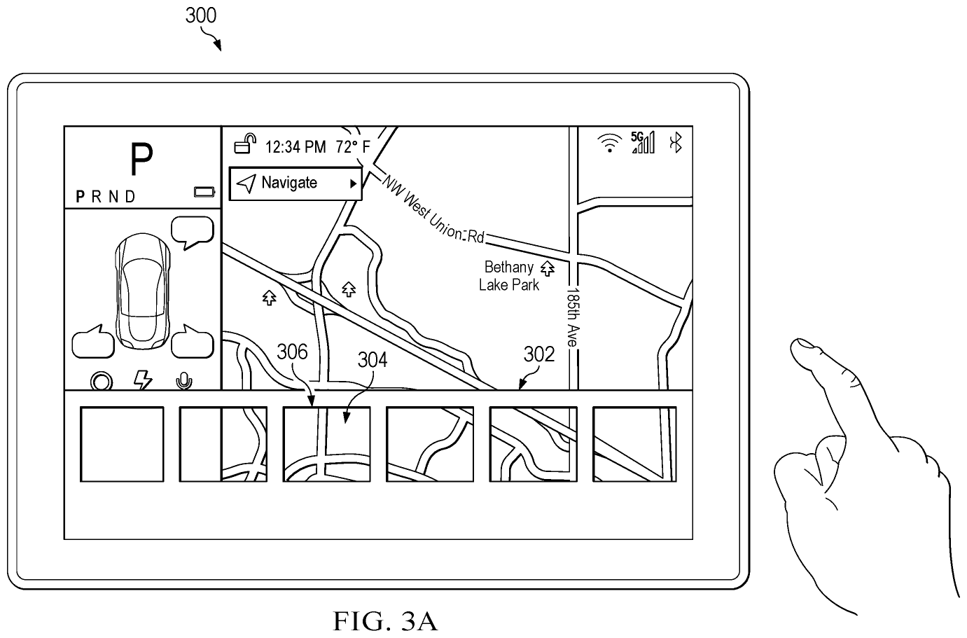

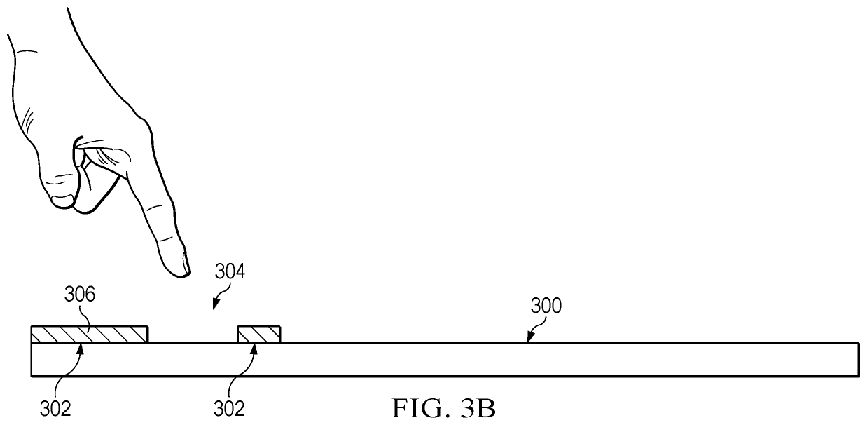

FIG. 3A depicts a perspective view of a grid mounted to a touch screen in accordance with an illustrative embodiment. FIG. 3B depicts a side cross-section view of the grid mounted on the touch screen. For ease of illustration, FIGS. 3A and 3B are not drawn to scale.

Touch screen 300 might be incorporated into the dashboard or console of a vehicle such as an aircraft. In this embodiment, the touch screen 300 is fitted with an external mechanical grid 302 that provides regions 304 within which actuators (e.g., buttons) can be located on the touch screen 300. The user interface designer has flexibility to specify where actuators are located on touch screen 300 and can locate them within the regions 304 according to the designer's preference. Therefore, the grid 302 leaves these regions 304 exposed for the user (e.g., pilot) to touch and activate touch screen actuators and controls displayed on the touch screen 300 according to the interface design.

The tactile feedback provided by the relief of edges 306 of the grid outlines (shown more clearly in FIG. 3B) around the touch screen actuators makes it easier for users to feel their way around and locate the specific regions 304 in question without requiring their direct visual attention. In this way, users can rely either entirely on feel or feel plus their peripheral vision to get their hands in the approximate position and rely on the tactile feedback of the grid edges 306 to guide their fingers to the exact position of the touch screen actuators without ever having to look directly at the touch screen 300, and, as such, without having to avert their eyes from the visual area(s) on which they need to direct their main focus. Furthermore, the surface of grid 302 can be textured differently around each actuator to help the user differentiate Actuator 1 from Actuator 2, etc., without the need for a confirming glance toward the touch screen 300.

The touch screen 300 can be customized such that the subsections of the grid material proximal to the open regions 304 overlay sections of the touch screen that trigger at least one of vibration or sound responsive to pressure exerted through the material of the grid 302. In this way, the tactile feedback provided by the material of the grid 302 can be supplemented with additional haptic feedback like vibration and/or with one or more associated sounds to indicate whether the user is getting closer to an actuator. The vibration and/or sound(s) might also be different for each actuator. For example, a voice synthesizer might name the actuator the user's finger is approaching.

Furthermore, the grid 302 and its respective edges or borders 306 also provide resting surfaces on which users can place their fingers in proximity of touch screen actuators in anticipation of touching them. By resting their fingers on the edges 306 of the grid 302, users do not have to hold their fingers suspended over the touch screen 300, which could lead to inadvertent activation of an actuator due to either fatigue, misjudgment or unanticipated movement of the vehicle.

The grid 302 can be designed to encompass the touch screen actuators and controls on the touch screen 300 most likely to require touching during operation of the vehicle while in transit. Such prioritization can help maintain the undivided visual attention of the operator in the direction of travel and surrounding environment. Less “urgent” actuators that typically are not activated during transit can be placed outside the actuator regions 304 encompassed and defined by the mechanical grid 302.

Technology available to pilots in the cockpit is increasing, including commanding pilots as well as co-pilots who have more sensors to potentially control inputs to and/or read outputs from, with more potential effects. For example, in the teaming of crewed and uncrewed vehicles, a human pilot might have the ability to control numerous autonomous vehicles and/or evaluate sensor data from many platforms. In such situations, controls are needed to direct the uncrewed teammates at the mission level, e.g., to begin coordinated maneuver, as in a formation flight, or directing a specific vehicle to take a specific action, e.g., exit the formation. Haptic features such as those provided by grid 302 enable prioritization of vehicle-specific, mission/team-specific, or single-teammate-specific commands to enable pilot selection and activation with minimal effort. This approach also avoids the need for a cockpit redesign whenever a new interface is required.

The touch screen 300 can accommodate multiple/nested uses. Haptic prioritization can be applied to controls for changing the “mode” in which the touch screen is operating.

For conventional aircraft controls, current flight decks use digital displays, but all user inputs are provided through physical buttons. The entire front panel of a cockpit can be replaced with a touch screen such as touch screen 300, with haptic feedback features provided for touch activated actuators on the screen that replace the physical input buttons of current conventional digital displays. This approach can enable a single cockpit design to be used across different classes of vehicles. Alternatively, a single cockpit can be more rapidly updated with new capabilities.

The touch screen haptic feedback approach of the illustrative embodiments can also be applied to ground station control (i.e., remote pilots) as well as other vehicle interfaces (e.g., ground and seaborne vehicles).

Grid 302 can be made of a suitable material, e.g., rubber, plastic, or metal. If metal is used, it can be coated by insulating material such as conventional powder coating. Plastic or metal grids can be stamped or laser cut. A plastic grid could also be made by cast or injection molding.

The grid 302 can be permanently or detachably attached or otherwise in physical communication to/with touch screen 300. For example, grid 302 may be attached to touch screen 300 by adhesive or can be mounted on a dashboard or instrument panel over the touch screen 300. Grid 302 also can be formed so as to be able to “snap over” the touch screen 300 similar to a case or screen protector for a mobile device/tablet.

Though the present example illustrated in FIGS. 3A and 3B depicts square actuator regions 304 in the grid 302, the open regions could be any shape such as rectangular, circular, hexagonal, octagonal, etc., as long as the touch screen actuator with the open region is sufficiently accessible by the user.

FIG. 4A depicts a diagram of mechanical membrane actuators to provide haptic feedback for a touch screen actuator press in accordance with an illustrative embodiment. FIG. 4B depicts a side cross-section view of the membrane actuators mounted on the touch screen. Again, for ease of illustration, FIGS. 4A and 4B are not drawn to scale.

In this embodiment, a number of membrane actuators 402 are attached to or otherwise in physical communication with/to the touch screen 400 and placed over specified touch screen actuators/controls. Similar to the grid 302 in FIGS. 3A and 3B, the membrane actuators 402 provide tactile feedback to the user, thereby guiding the user's finger to the touch screen actuator in question without the user having to shift direct visual focus to the touch screen 400.

Each membrane actuator 402 comprises a rigid or semi-rigid outer area (e.g., outer ring) 404 and a flexible inner membrane 406 with a defined open region 408 that leaves the underlying touch screen actuator exposed. As shown more clearly in the cross-section view in FIG. 4B, the flexible inner membrane 406 provides a surface that the user's finger can follow tactilely to find the open region 408 over the touch screen actuator in question. The inner membrane 406 can be made of a flexible material such as silicone rubber.

Similar to the grid embodiment above, the touch screen 400 can be customized such that the membrane actuators 402 overlay sections of the touch screen 400 that trigger at least one of vibration or sound responsive to pressure exerted through the membrane actuators. In this way, the tactile feedback provided by the material of the membrane actuators 402 can be supplemented with additional haptic feedback like vibration and/or with sounds to indicate whether the user is getting closer to an actuator. The vibration and/or sound might also be different for each actuator. For example, a voice synthesizer might name the actuator the user's finger is approaching.

Similar to the grid 302 in FIGS. 3A and 3B, the operator can find the membrane actuators 402 with peripheral vision and rely on tactile guidance from the outer ring 404 and inner membrane 406 to “home in” on the exact position of the touch screen actuator. The outer ring 404 and inner membrane 406 can also serve as resting surfaces for the user's finger in anticipation of touching a touch screen actuator without the user having to hold their finger suspended over the touch screen 400.

The membrane actuators 402 can be permanently or detachably attached to the touch screen 400 or otherwise in physical communication thereto/therewith.

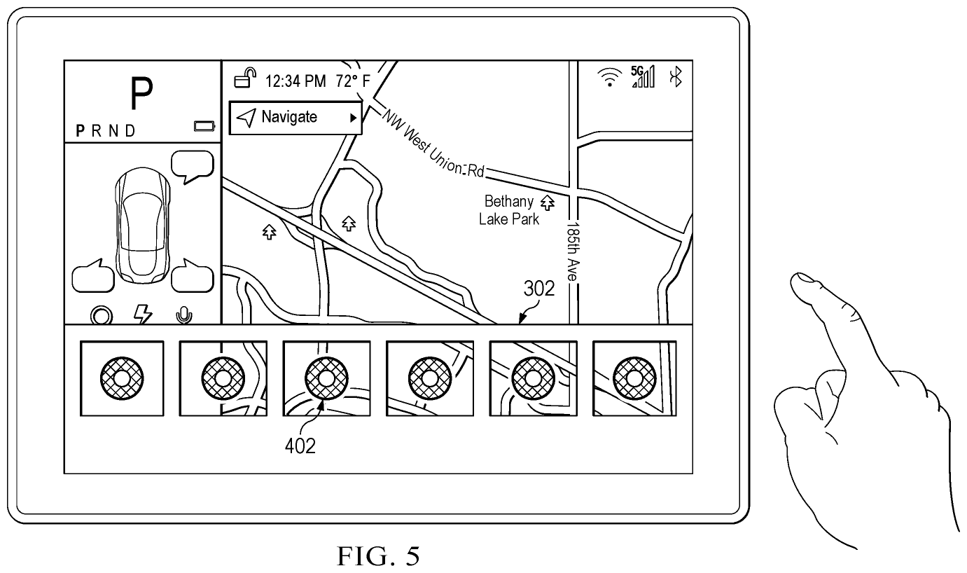

FIG. 5 is a diagram of a hybrid haptic system including a mechanical grid and membrane actuators in accordance with an illustrative embodiment. In this embodiment, the membrane actuators 402 are located within the open actuator regions of the mechanical grid 302.

By employing both the tactile feedback of a grid with that of membrane actuators, this embodiment can provide an increasing gradation of precision in tactilely guiding the user's finger to actuators on the touch screen. The grid 302 can provide an initial tactile reference point for the user to locate the approximate location of the touch screen actuator in question, and once in the right area, the membrane actuator can provide more precise guidance to the exact location of the touch screen actuator location.

Both the grid 302 and membrane actuators 402 can be either permanently or detachable connected to the touch screen or otherwise in physical communication therewith/thereto. If either or both are detachably connected, haptic feedback can be customized for different users of the same vehicle and/or for different operating conditions. For example, if the vehicle is going to be operated in a rougher environment (e.g., potential rough weather for an aircraft) that requires heightened visual focus during travel, both the grid 302 and membrane actuators 402 might be used to provide the user with increased precision of tactile guidance in properly finding and touching the correct touch screen actuators.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A touch screen haptic system having a plurality of touch activated actuators for providing input, the system comprising:
a number of actuators attached to a touch screen, wherein each actuator comprises:
an outer ring; and
an inner membrane with an open area that exposes a touch activated actuator of the touch screen to touch, wherein the at least one of the number of actuators overlays a section of the touch screen that triggers at least one of vibration or sound responsive to pressure exerted through the at least one actuator.

2. The touch screen haptic system of claim 1, wherein the outer ring of each actuator is rigid or semi-rigid.

3. The touch screen haptic system of claim 1, wherein the inner membrane is made of rubber.

4. (canceled)

5. A touch screen haptic system having a number of touch activated actuators for providing input, the system comprising:
an overlay material placed over a touch screen, wherein a number of open areas are defined within the overlay material to provide tactile access to the touch activated actuators, and wherein edges of the open areas are in sized and/or shaped to provide tactile feedback to a user regarding the approximate locations of the touch activated actuators, wherein subsections of the overlay material proximal to the open areas trigger at least one of vibration or sound responsive to pressure exerted through the overlay material.

6. The touch screen haptic system of claim 5, wherein the overlay material is permanently attached to the touch screen.

7. The touch screen haptic system of claim 5, wherein the overlay material is detachably attached to the touch screen.

8. The touch screen haptic system of claim 5, wherein the overlay material comprises a grid.

9. (canceled)

10. The touch screen haptic system of claim 5, wherein the overlay material has different texturing around different open regions.

11. A touch screen haptic system having a plurality of touch activated actuators for providing input, the system comprising:
an overlay material placed over a touch screen, wherein a number of open areas are defined within the material to provide tactile access to the touch activated actuators, and wherein portions of the open regions are sized and/or shaped to provide tactile feedback to a user regarding the approximate locations of the touch activated actuators; and
a number of membrane actuators attached to the touch screen, wherein the membrane actuators are located within the open regions of the overlay material, and wherein each membrane actuator comprises an outer ring and a flexible inner membrane with an open center that exposes a touch activated actuator to touch, wherein the membrane actuators overlay sections of the touch screen that trigger at least one of vibration or sound responsive to pressure exerted through the membrane actuators.

12. The touch screen haptic system of claim 11, wherein the outer rings of the membrane actuators are rigid.

13. The touch screen haptic system of claim 11, wherein the outer rings of the membrane actuators are semi-rigid.

14. The touch screen haptic system of claim 11, wherein the inner membranes of the membrane actuators are made of silicon rubber.

15. The touch screen haptic system of claim 11, wherein at least one of the overlay material and membrane actuators are permanently attached to the touch screen.

16. The touch screen haptic system of claim 11, wherein at least one of the overlay material and membrane actuators are detachably attached to the touch screen.

17. The touch screen haptic system of claim 11, wherein the overlay material comprises a grid.

18. The touch screen haptic system of claim 11, wherein the overlay material has different texturing around different open regions.

19. (canceled)

20. The touch screen haptic system of claim 11, wherein subsections of the overlay material proximal to the open areas overlay sections of the touch screen that trigger at least one of vibration or sound responsive to pressure exerted through the overlay material.

21. The touch screen haptic system of claim 1, further comprising an overlay material placed over the touch screen.

22. The touch screen haptic system of claim 21, wherein the overlay material comprises a grid.

23. The touch screen haptic system of claim 21, wherein the overlay material has different respective texturing around different open regions.
